(19) United States
(12) Patent Application Publication
(10) Pub. No.: US 2022/0397691 A1
(43) Pub. Date: Dec. 15, 2022

(54) SYSTEM AND METHOD FOR REDUCING STATICS IN SEISMIC IMAGING

(71) Applicant: Jie ZHANG, Houston, TX (US)

(72) Inventor: Jie ZHANG, Houston, TX (US)

(21) Appl. No.: 17/841,488

(22) Filed: Jun. 15, 2022

Related U.S. Application Data
(60) Provisional application No. 63/210,765, filed on Jun. 15, 2021.

(51) Int. Cl. G01V 1/38; G01V 1/30

(52) U.S. Cl. CPC G01V 1/3808; G01V 1/301

(57) ABSTRACT

The present embodiments describe a system and method for generating one or more predictive models to reduce the static interference present in seismic reflection studies. The system can include a user device and a server. The method proceeds with gathering historical data, generating synthetic data, generating a predictive model based on those data sets, and applying that model to a current set of a data to calculate a seismic reflection of a geological space.

### CROSS-REFERENCE TO RELATED PATENT APPLICATIONS

This application claims priority to U.S. Provisional Application No. 63/210,765, filed Jun. 15, 2021, the contents of which are incorporated herein in its entirety.

### FIELD OF THE DISCLOSURE

The present disclosure relates to a system and method for generating one or more predictive models configured to reduce static interference in seismic imaging.

### BACKGROUND

Making statics corrections is very important in land and shallow marine data processing to compensate for the effects of variations in elevation, weathering thickness, and weathering velocity in the near-surface area. After long-wavelength statics correction associated with major structures, residual statics correction is often needed and derived by applying a data-based method. In complex land and shallow marine areas, failure to correct the residual statics may lead to poor-quality stack and migration images.

These and other deficiencies exist. Therefore, there is a need to provide an imaging method that overcomes these deficiencies.

Residual statics can be inferred from reflection data by aligning reflection events (Taner et al., 1974; Wiggins et al., 1976; Koglin et al., 2006) or by maximizing the stack power (Ronen and Claerbout, 1985; Rothman, 1986; Wilson et al., 1994; Abbas et al., 2018). Aligning reflection events is to decompose the time shift between an individual trace and a pilot trace into residual statics, residual moveout, and structure variation. However, the quality of the pilot trace may be affected by approximations in the normal moveout (NMO) correction, errors in the NMO velocity, and large residual statics (Jin and Ronen, 2006; Gholami, 2013). Maximizing stack power for estimating surface-consistent residual statics has been the gold standard in the seismic industry, in which residual statics solution is also coupled with stacking velocity analysis and NMO correction. Moderate residual statics problems may degrade the capability for stacking velocity analysis and subsequent errors in the NMO velocities may affect the stacking quality (Malehmir and Juhlin, 2010). A solution to the problem is to iterate the residual statics correction and velocity analysis process, which becomes time-consuming and tedious. Efforts are also made to solve the residual statics without conducting velocity analysis and NMO correction (Gholami, 2013; Darwish et al., 2018) by applying the sparsity assumption in different domains, for example, curvelet domain, Fourier domain, or intercept-velocity domain. They solve a nonlinear optimization problem iteratively and may converge to a local maximum for large residual statics problem. In addition, several residual statics methods are developed using refraction traveltimes or waveforms (Hatherly et al., 1994; Zhu and Luo, 2004; Zhang and Zhang, 2016; Duan and Zhang, 2017; Gao and Zhang, 2017). Those methods can resolve the residual statics problem only if refracted and reflected waves pass through the weathering layer with similar travel paths.

An effective assumption is that residual statics correction is surface-consistent, which implies that a correction is associated with shot and receiver surface locations. This is consistent with a physical influence of the near surface structures. Such a correction affects all events with a constant shift along a trace in data. Those characteristics can be analyzed to help identify residual statics from raw data or de-noised data directly without conducting the stacking velocity analysis and NMO correction as in the crosscorrelation or stack-power maximization methods.

### SUMMARY OF THE DISCLOSURE

Embodiments of the present disclosure provide a method comprising the steps of: retrieving, by a processor, one or more sets of historical data; generating, by the processor, one or more sets of synthetic data; analyze, by a predetermined algorithm, one or more trends in the historical data and the synthetic data; generate, by the processor upon analyzing the trends in the historical data and the synthetic data, a predictive model configured to calculate any errors present in their respective data sets; apply the predictive model to a current set of a data, the application comprising one or more iterations; and generate, upon applying the predictive model, one or more visual models with reduced errors.

Embodiments of the present disclosure provide a system for generating a predictive model configured to correct residual errors in data-mapping, the system comprising: a memory; and a processor configured to: retrieve one or more sets of historical data; generate one or more sets of synthetic data; analyze, by a predetermined algorithm, one or more trends in the historical data and the synthetic data; generate, upon analyzing the trends in the historical data and the synthetic data, a predictive model; apply the predictive model to one or more sets of current data; and generate, upon applying the predictive model, one or more visual models with reduced errors.

Embodiments of the present disclosure provide a computer readable non-transitory medium comprising computer executable instructions that, when executed on a processor, perform procedures comprising the steps of: retrieving one or more sets of historical data; generating one or more sets of synthetic data; analyzing, by a predetermined algorithm, one or more trends in the historical data and the synthetic data; generating, upon analyzing the trends in the historical data and the synthetic data, a predictive model; applying the predictive model to one or more sets of current data; and generating, upon applying the predictive model, one or more visual models with reduced errors.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a block diagram illustrating a system according to an exemplary embodiment.

FIG. 2 is a flowchart illustrating a process according to an exemplary embodiment.

FIG. 3 is a flowchart illustrating a process according to an exemplary embodiment.

FIGS. 4A-4B are charts illustrating gathers and outputs according to an exemplary embodiment.

FIGS. 5A-5C is a method flowchart illustrating a method according to an exemplary embodiment.

FIGS. 6A-6I is a series of velocity models for generating training data according to an exemplary embodiment.

FIG. 7A-7F are charts illustrating gathers and outputs according to an exemplary embodiment.

FIG. 8A-8C are charts illustrating static reduction according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Our goal is to directly predict surface-consistent residual statics from common-shot, common-receiver, or common-midpoint (CMP) gathers without conducting velocity analysis and NMO correction. The input data consist of one gather of reflections in any domain, and the output of the neural network is the residual statics for all of the traces in the input gather.

Maximizing stack power for estimating surface-consistent residual statics is the gold standard in the seismic industry. The input CMP gathers for the stack power maximization method should be NMO corrected using NMO velocities. The NMO velocity is manually picked from the velocity spectrum. For the stack power maximization configuration in the first dataset, the maximum allowable shift is 20 ms, the time window is from 500 ms to 3000 ms, and the number of iterations is 3. For the configuration in the second dataset, the maximum allowable shift is 15 ms, the time window is from 300 ms to 1300 ms, and the number of iterations is 3.

The difference between those two shot residual statics solutions is small. For the receiver residual statics, compared with the trained model, the stack power maximization method produces much larger residual statics in several distant receivers.

The trained model, model-dat, can obtain stacked sections comparable to the stack power maximization method. However, our method avoids the time-consuming and tedious NMO velocity picking process and only takes a few minutes to obtain the final residual statics from thousands of pre-NMO-corrected gathers.

Since the input of the stack power maximization method is NMO-corrected data, the stack power maximization method is affected by errors in the picked NMO velocities or the breakdown of the NMO assumption. For the third test dataset, there are large lateral velocity variations in the middle region, which can be implied from the migration section. For the stack power maximization configuration, the maximum allowable shift is 20 ms, the time window is from 500 ms to 4000 ms, and the number of iterations is 3.

Conventional reflection residual statics correction is based on some assumptions. First, maximizing the stack power is based on the NMO corrected CMP gathers. The hyperbolic assumption is essential for NMO correction. When there is a large lateral variation in the subsurface velocity, the hyperbolic assumption will break down. In this study, the developed method can directly estimate residual statics from reflections without NMO correction. The key task for the trained model is to identify the features of static distortions and predict the residual statics. As a result, our method is not limited to the approximation of the NMO correction process, especially in complex exploration areas. In addition, a complexity in the subsurface may cause static distortions in a relatively small time window; however, static distortions along the whole trace often result from near-surface irregularities. Moreover, the surface-consistent assumption is the most important assumption for residual statics correction. In this study, we also rely on the surface-consistent assumption to formulate our problem and generate a large number of labeled samples.

In this study, based on HRnet, we develop a residual statics correction method without conducting stacking velocity analysis and NMO correction. We also implement several data augmentation methods based on the surface consistency of residual statics. A prediction head is designed for multiscale training and multiscale testing. The trained model can be effectively applied in new synthetic and real datasets to predict residual statics and improve the stacked section. With higher efficiency, the trained model can obtain stacked sections comparable to that of the stack power maximization method.

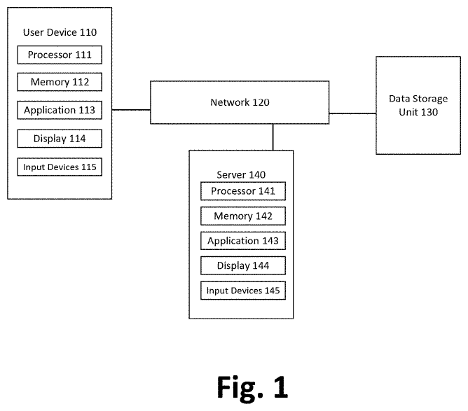

FIG. 1 is a block diagram according to an exemplary embodiment. FIG. 1 illustrates a system 100 according to an example embodiment. The system 100 may comprise a user device 110, a network 120, a data storage unit 130, and a server 140. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 110 may include a processor 111, a memory 112, and an application 113. The processor 111 may be a processor, a microprocessor, or other processor, and the user device 110 may include one or more of these processors. The processor 111 may include processing circuitry, which may comprise additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may often not be rewritten, but it may be read many times. A read/write memory may be programmed and re-programed many times after leaving the factory. It may also be read many times. The memory 112 may be configured to store one or more software applications, such as the application 113, and other data, such as user's private data and other information.

The application 113 may comprise one or more software applications, such as a mobile application and a web browser, comprising instructions for execution on the user device 110. In some examples, the user device 110 may execute one or more applications, such as software applications, that enable, for example, network communications with one or more components of the system 100, transmit and/or receive data, and/or perform the functions described herein. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touchscreen, keyboard, mouse, cursor-control device, microphone, digital camera, video recorder or camcorder. These devices may be used to enter information and interact with the software and other devices described herein.

System 100 may include one or more networks 120. In some examples, the network 120 may be one or more of a wireless network, a wired network or any combination of a wireless network and a wired network and may be configured to connect the user device 110, the server 140, and the data storage unit 140. For example, the network 120 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 120 may include, without limitation, telephone lines, fiber optics, IEEE Ethernet 902.3, a wide area network, a wireless personal area network, a LAN, or a global network such as the Internet. In addition, the network 120 may support an Internet network, a wireless communication network, a cellular network, or the like, or any combination thereof. The network 120 may further include one network, or any number of the exemplary types of networks mentioned above, operating as a stand-alone network or in cooperation with each other. The network 120 may utilize one or more protocols of one or more network elements to which they are communicatively coupled. The network 120 may translate to or from other protocols to one or more protocols of network devices. Although the network 120 is depicted as a single network, it should be appreciated that according to one or more examples, the network 120 may comprise a plurality of interconnected networks, such as, for example, the Internet, a service provider's network, corporate networks, and home networks. The network 120 may further comprise, or be configured to create, one or more front channels, which may be publicly accessible and through which communications may be observable, and one or more secured back channels, which may not be publicly accessible and through which communications may not be observable.

System 100 may include a data storage unit 130. The data storage unit 130 may be one or more data storage units configured to store technical or other data, including without limitation, private data of users or operators, accounts of users or operators, identities of users o operators, and certified and uncertified documents. The data storage unit 130 may comprise a relational data storage unit, a non-relational data storage unit, or other data storage unit implementations, and any combination thereof, including a plurality of relational data storage units and non-relational data storage units. In some examples, the data storage unit 130 may comprise a desktop data storage unit, a mobile data storage unit, or an in-memory data storage unit. Further, the data storage unit 130 may be hosted internally by the server 140 or may be hosted externally of the server 140, such as by a server, by a cloud-based platform, or in any storage device that is in data communication with the server 140.

System 100 may include a server 140. The server 140 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 140 may include a processor 141, a memory 142, and an application 143. The processor 141 may be a processor, a microprocessor, or other processor, and the server 140 may include one or more of these processors. The processor 141 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 141 may be coupled to the memory 142. The memory 142 may be a read-only memory, write-once read-multiple memory or read/write memory, e.g., RAM, ROM, and EEPROM, and the server 140 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it often may not be rewritten, but it may be read many times. A read/write memory may be programmed and re-programed many times after leaving the factory. It may also be read many times. The memory 142 may be configured to store one or more software applications, such as the application 143, and other data, such as user's private data and account information.

The application 143 may comprise one or more software applications comprising instructions for execution on the server 140. In some examples, the server 140 may execute one or more applications, such as software applications, that enable, for example, network communications with one or more components of the system 100, transmit and/or receive data, and perform the functions described herein. Upon execution by the processor 141, the application 143 may provide the functions described in this specification, specifically to execute and perform the steps and functions in the process flows described below. For example, the application 143 may be executed to perform receiving web form data from the user device 110 and the storage device 130, retaining a web session between the user device 110 and the storage device 130, and masking private data received from the user device 110 and the storage device 130. Such processes may be implemented in software, such as software modules, for execution by computers or other machines. The application 143 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 140 may further include a display 144 and input devices 145. The display 144 may be any type of device for presenting visual information such as a computer monitor, a flat panel display, and a mobile device screen, including liquid crystal displays, light-emitting diode displays, plasma panels, and cathode ray tube displays. The input devices 145 may include any device for entering information into the server 140 that can be available and supported by the server 140, such as a touchscreen, keyboard, mouse, cursor-control device, microphone, digital camera, video recorder or camcorder. These devices may be used to enter information and interact with the software and other devices described herein.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the user device 110, the server 140, the network 120, and the data storage unit 130 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

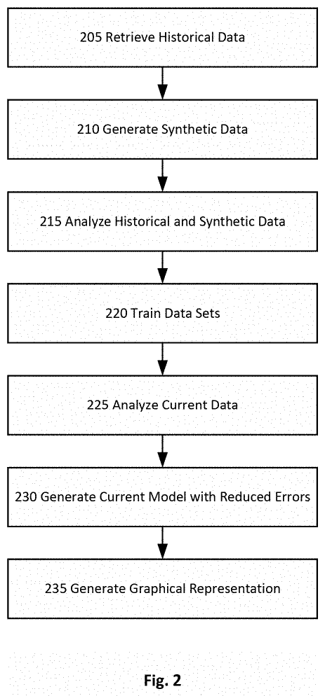

FIG. 2 is a flowchart illustrating a process according to an exemplary embodiment. The process can include a user device and a server.

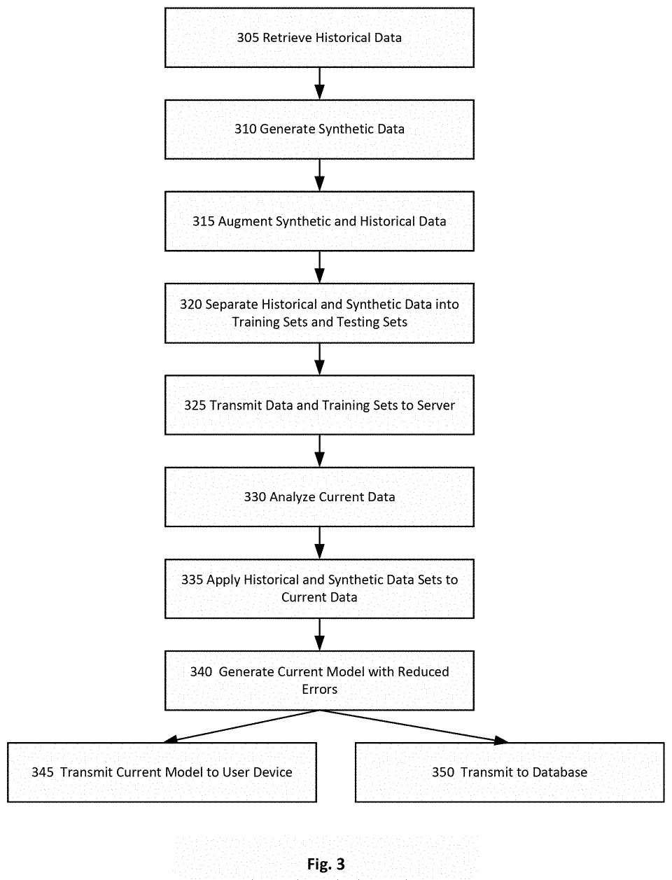

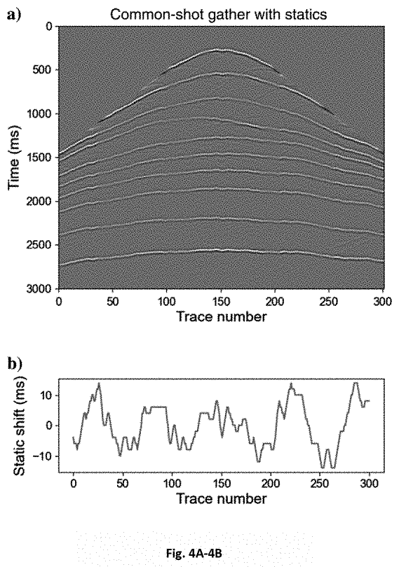

In action 205, a processor can retrieve historical data. The historical data can be data that has previously been observed, recorded, or otherwise stored. The historical data can include without limitation geological and seismic data including residual statics, topographical data, tomographical data, fault data, soil data, or other data. The historical data can be retrieved from within a server or database, or it can be transmitted from an administrator processor to a user device. Additionally, the historical data can include seismic two-dimensional data and three-dimensional data. In action 210, the synthetic data can be generated. The synthetic data can be generated with the intention of supplying the predictive models with more data. The synthetic data can be modeled after real world or theoretical data. When preparing both the historical or synthetic data, the processor can ensure that such data optionally has no residual statics. This is so that the data can be optionally augmented with synthetic residual statics. In action 215, the processor can analyze the historical and synthetic data. The processor can be associate with a server or some other device. The analysis can include one or more neural network including a convolutional neural network (CNN) or recursive neural network (RNN). CNNs are discussed with further reference to FIG. 5. The analysis can be directed at determining trends, errors, residual statics, geological formations, or accuracy associated with the data. 3 As another nonlimiting example, the synthetic data can be analyzed to determine how static reflection might be generated if certain elements of the historical data were synthetically or manually change. As another nonlimiting example, the synthetic data can be based on completely fictional geological spaces. Having analyzed the data, the processor in action 220 can train the data sets. The training of one or more data sets is discussed with further reference to FIG. 5. The training of the data sets can be achieved after a number of iterations, changes in inputs, adjustments in outputs, and other changes are made to the elements of the models. In action 225, the processor can apply the predictive model to a current set of data. The current set of data can be data that has not yet been analyzed or is otherwise separate from the historical data and the synthetic data. The current data can be any geological or topographical space recorded by a device or processor. The current data can include without limitation reflection statics or seismic data including the recordation of any energy waves or sound waves into the earth and recording the wave reflections to indicate the type, size, shape, and depth of subsurface rock formation. Additionally, the current data can include marine data. Additionally, seismic data can be recorded in the form of seismic traces, also known as seismograms which directly represent the response of the elastic wavefield to velocity and density contrasts across interfaces of layers of rock or sediments as energy travels from a source through the subsurface to a receiver or receiver array. Having applied the models to the current data, in action 230 the processor can generate a current model of the current data after a predetermined number of iterations. The current model can be generated as combination or average of the historical model and synthetic model. In action 235, a graphical representation of the current data model can generated by a processor. The processor can be associated with a server.

FIG. 3 is a flowchart illustrating a process according to an exemplary embodiment.

In action 305, a processor can retrieve historical data. The historical data can be data that has previously been observed, recorded, or otherwise stored. The historical data can include without limitation geological and seismic data including residual statics, topographical data, tomographical data, fault data, soil data, or other data. The historical data can be retrieved from within a server or database, or it can be transmitted from an administrator processor to a user device. Additionally, the historical data can include seismic two-dimensional data and three-dimensional data. In action 310, the processor can generate one or more sets of synthetic data. The synthetic data can be generated with the intention of supplying the predictive models with more data. The synthetic data can be modeled after real world or theoretical data. When preparing both the historical or synthetic data, the processor can ensure that such data optionally has no residual statics. This is so that the data can be optionally augmented with synthetic residual statics. In action 315, the processor can augment the augment the synthetic and historical data further. This augmented data can include different or adjusted elements such as different depths, shot or receive locations, or other geological and topological changes. This augmented data is then applied to the historical and synthetic data sets. In action 320, the processor can separate the historical and synthetic data into training sets and testing sets. The training sets can be configured to train the sets of historical and synthetic data to arrive at a most accurate prediction for any give set of current data. The testing sets can be configured to test the training sets to confirm that the training sets have arrived as a sufficient ability to predict static residuals. In action 325, the processor can transmit the training and testing sets to a server. The server can include one or more processors. Furthermore, the server can include cloud computing, including but not limited to private clouds, public clouds, multiclouds, and hybrid clouds. The server can process the sets fast and provide results in quicker and more efficient manner. In action 330, the server can analyze the current data. The generation of these models is discussed with further reference to FIG. 5. The analysis of the current data can include without limitation data classification, data categorization, determining trends in the data, comparing the current data to historical or synthetic data, or making preliminary observations about the data related to residual statics. Upon generating the models, in action 335 the processor can apply both the historical and synthetic data sets to the current set of a data. The current set of data can be data that has not yet been analyzed or is otherwise separate from the historical data and the synthetic data. The current data can be any geological or topographical space recorded by a device or processor. The current data can include without limitation reflection statics or seismic data including the recordation of any energy waves or sound waves into the earth and recording the wave reflections to indicate the type, size, shape, and depth of subsurface rock formation. Additionally, the current data can include marine data. Additionally, seismic data can be recorded in the form of seismic traces, also known as seismograms which directly represent the response of the elastic wavefield to velocity and density contrasts across interfaces of layers of rock or sediments as energy travels from a source through the subsurface to a receiver or receiver array. In action 340, the processor can generate a current model of the geological or topographical space with reduced errors. The generation of the current model can be achieved after a number of iterations. Furthermore, the generation of the current model can finish only after it reaches a predetermined point of accuracy. In action 345, the current model can be transmitted to a user device, administrator processor, other server, or some other device suitable for viewing the model. This action can be performed by a processor associated with the server. In action 350, the processor can transmit the current model to a database.

FIGS. 4A-4B illustrates shows input samples and their corresponding outputs. FIG. 4a shows one input sample and FIG. 4B shows the corresponding output.

Our goal is to directly predict surface-consistent residual statics from common-shot, common-receiver, or common-midpoint (CMP) gathers without conducting velocity analysis and NMO correction. The input data consist of one gather of reflections in any domain, and the output of the neural network is the residual statics for all of the traces in the input gather. FIG. 4A shows one input sample and FIG. 4B shows the corresponding output. The neural network architecture will be designed to automatically adjust the number of output residual statics according to the number of traces in the input gather. In the training process, data preprocessing first needs to be conducted to remove surface waves and refractions and to balance amplitude. Each trace in the input should be normalized into the range from −1 to 1. Due to the similar reflection moveout patterns in common-shot, common-receiver, and CMP gathers, the training data set consists of those three types of gathers. In the prediction process, the same preprocessing as for the training data sets also is conducted for new data sets. The trained neural network can directly predict the residual statics for all of the traces in the input gather, again repeating the estimation process for all of the gathers separately. To obtain the final shot and receiver residual statics under the surface consistency assumption, we average all the predicted residual statics related to the same shot or receiver and take the mean value as the shot residual statics or receiver residual statics.

FIG. 5A-5C illustrates a process of using a CNN to train large amounts of data.

In this study, we use HRnet (Sun et al., 2019; Wang et al., 2020), shown in FIG. 5a, as the backbone to learn high-resolution representations. HRnet can maintain high-resolution representations throughout the entire process. HRnet has achieved state-of-the-art results in many resolution-sensitive problems. HRnet starts from a high-resolution convolution stage, gradually adding high-to-low resolution branches, forming new stages. FIG. 5A shows four stages and four parallel branches. Inside each stage, the convolution unit is the residual module (He et al., 2016). There are two residual modules in each stage. The channel numbers of all branches in the four stages are (32), (16, 32), (16, 32, 64), and (16, 32, 64, 128). Between different stages, there is a multiresolution fusion module, which is based on upsampling, downsampling, and addition. FIG. 5B shows the detailed multiresolution fusion module between the second stage and the third stage. The upsampling process is based on a 1×1 convolution and bilinear upsampling. The downsampling process is achieved by one or more stride-2 convolutions. The convolution unit between two stages consists of convolution, batch normalization, and rectified linear unit (ReLU) activation. For the residual statics problem, we further modify the architecture. Because the network predicts a static shift for each trace, we only apply stride-2 convolution in the time direction. In addition, batch normalization (Ioffe and Szegedy, 2015) in the residual module will degrade if the batch size is too small. Due to the large model and the limited memory in our graphics processing unit (GPU; GTX 1080Ti), the batch size should be small. Therefore, we replace batch normalization in the network with group normalization (Wu and He, 2018), which is not sensitive to the batch size. In seismic data, the number of traces in a gather may vary due to acquisition geometry. We should design the network head to adapt multiscale training and multiscale testing. The detailed network prediction head is shown in FIG. 5C. We upsample the feature maps from different branches into the highest resolution and concatenate them together, followed by a 1×1 convolution. We use an adaptive average pooling module to automatically adjust the pooling size according to the input and output size. If we denote the channel, height, and width of the feature map as c, h, and w, respectively, the pooling size will be h×1 and the size of the pooling output will be c×1×w. After a 1×1 convolution, we can change the channel number to 1 and the size of the final output is 1×1×w. In this study, c is equal to 240, which is obtained by adding the number of channels from the four branches in stage 4. Here, w and h are automatically adapted to the number of seismic traces and time samples, respectively. Finally, the loss function for one sample is shown as follows:

$$Loss = \frac{1}{N} {\sum }_{i = 1}^{N} {smooth}_{L 1} ( {y}_{i} - {\hat{y}}_{i} ) , \qquad ( 1 )$$

$${smooth}_{L 1} ( x ) = \{ \begin{matrix}0.5 {x}^{2} , if x < 1 \\ \vert x - 0.5 \vert , otherwise\end{matrix} , \qquad ( 2 )$$

where N is the number of traces in one seismic gather. yᵢ is the labeled residual static shift in the iₜₕ trace and ŷᵢ is the predicted residual static shift for the iₜₕ trace. The smooth L1 norm has been shown to perform better than the L2 norm in deep learning regression problems (Ren et al., 2016). To make our method not limited to the time sampling rate, we divide yᵢ and ŷᵢ by the time sampling rate in practice. In addition, to mitigate overfitting, we apply 2-norm weight decay during training and set it to 0.0001.

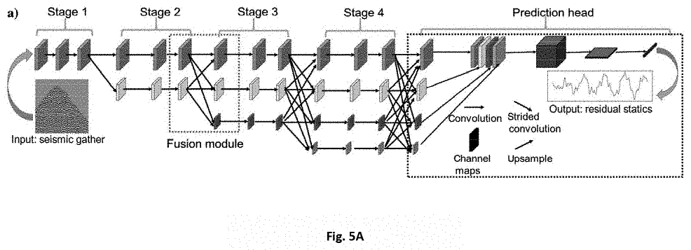

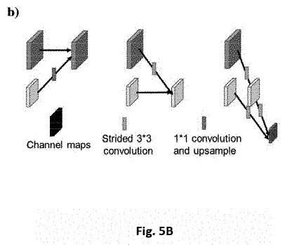

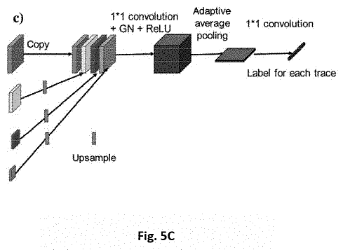

We further compare the HRnet and the U-net, which are widely adopted in geophysical applications (Hu et al., 2019; Wu et al., 2019) in estimating residual statics. The U-net architecture in our study is the same as that in Ronneberger et al. (2015). For a fair comparison, we set the channel numbers in the U-net's downsampling path to 10, 20, 40, 80, and 160, which makes the number of learnable parameters in those two networks similar. Other factors are set to be the same, for example, the prediction head, hyperparameters, and training data set. Finally, the training loss and the validation loss converge to 0.1 and 0.162, respectively. The residual statics errors for the training data set and validation data set are 0.2 and 0.324 ms, respectively. With lower validation loss than the U-net, the HRnet shows better generalization ability in the validation data set. To further validate the generalization ability, we test the trained models on samples generated from a different velocity model. FIGS. 6A-6I show the velocity model for generating the test data set. This model contains undulating reflectors, faults, and salt bodies. We generate 8000 test samples and add band-limited Gaussian noise to them. The mean value of the noise is 0, and the standard deviation is set to the maximum amplitude multiplied by a factor. The factor ranges from 0.1 to 0.7 in our study. The signal-to-noise ratio (S/N) is defined as follows:

$$S N R = 20 {log}_{10} \frac{R M {S}_{signal}}{R M {S}_{noise}} , \qquad ( 3 )$$

where RMS means the root mean square value. The SNR ranges from 1 dB to −16 dB. We apply those two trained models to test datasets with different SNRs. FIG. 5C shows the residual statics errors of the HRnet and the U-net as the SNR decreases. We observe that the residual statics error increases as SNR decreases and the residual statics error of the HRnet is lower than that of the U-net under the same SNR.

FIGS. 6A-6I are velocity models according to an exemplary embodiment.

To mitigate overfitting, CNNs with a large number of learnable parameters should be trained on large amounts of labeled data. However, creating a large number of training samples from seismic data is challenging due to low efficiency and high demand for human input. To use deep learning (DL) to solve a geophysical problem effectively, we must develop an approach to generate a large number of labeled samples with sufficient variety (Liu et al., 2021). In this study, based on the surface consistency of residual statics, we implement several data augmentation methods to generate a large number of training samples from synthetic and real data sets. For synthetic data sets, we design a few velocity models without the near-surface problem and conduct forward modeling. Under the surface-consistent assumption, we generate random short- to medium-wavelength statics and apply static shifts to seismic traces according to the shot and receiver locations. To obtain the short- to medium-wavelength statics, we first band-pass filter standard Gaussian random numbers. The bandwidth can be designed according to the trace spacing. Then, we rescale the random numbers into −1 to 1 and multiply the random numbers by a scaler, which is sampled from the Gaussian distribution with an expectation of 10 ms and a standard deviation of 5 ms. For real data sets, we repeat the process and apply static shifts to relatively statics-free reflection data, such as marine data or statics-corrected land data. We further augment the training data by adding random noise, reversing polarity, horizontally flipping, and cropping. Due to the similar reflection moveout patterns in common-shot, common-receiver, and CMP gathers, we train three types of gathers together but apply the trained model to any single type of gathers as input for statics estimation.

We first use the synthetic data sets to show the feasibility of our method and will test the trained model on different synthetic and real data sets. FIG. 6A-6H shows eight velocity models for training data set generation. There are one or two geologic structures (undulating reflector, fault, and salt body) in each velocity model. For each velocity model, we generate 80 shot gathers by forward acoustic modeling with a 3000 m maximum shot-receiver offset and a 20 m interval. We also synthesize 100 random surface-consistent short- to medium-wavelength statics and apply them to the synthetic data. Finally, we generate 64,000 samples. A total of 20% of adjacent consecutive seismic gathers form the validation data set for hyperparameter tuning. The remaining samples form the training data set. To globally evaluate the test results, we synthesize 400 shot gathers from the velocity in FIG. 6I, generate surface-consistent residual statics, apply them to 400 shot gathers, and add band-limited Gaussian noise to shot gathers. We apply trained models to those 400 shot gathers, average all the predicted residual statics related to the same receiver, and obtain the receiver residual statics. In addition, we also apply the stack power maximization method to the data with SNR of 1 dB. The NMO velocity is obtained by converting the synthetic interval velocity into the RMS velocity. The maximum allowable shift is 20 ms, the time window is from 500 ms to 4000 ms, and the number of iterations is 3.

Data distribution differences between training data and testing data may lead to prediction bias for the trained model. In this section, we train real datasets to ensure good generalization ability on real data processing. Using actual residual statics derived from many real datasets for training is not practical. To mitigate overfitting and improve generalization ability, based on the surface consistency of residual statics, we generate a large number of random surface-consistent short- to medium-wavelength statics and apply them to the relatively statics-free reflections, such as marine data or land data with effective statics corrections already applied.

We train two seismic datasets from two exploration areas. First, we carry out statics correction based on the inverted near-surface velocity model. For the first seismic dataset, the maximum shot-receiver offset is 3,600 m and the receiver interval is 30 m. For the second dataset, the maximum shot-receiver offset is 4,000 m and the receiver interval is 20 m. Then, preprocessing is conducted to remove surface waves and refractions, and to balance amplitude. After applying long-wavelength tomostatics, we apply the stack power maximization method to solve the residual statics problem for both datasets. Finally, we obtain the statics-free reflection data as a basis, and apply a large number of residual statics sets to common shot, common receiver, and common midpoint gathers for creating training and validation samples. From these two seismic datasets, we generate 102,090 labeled samples in total. 20 percent of adjacent consecutive seismic gathers form the validation dataset for hyperparameter tuning. The remaining samples from the training dataset.

In addition to the learning rate setting, the training scheme is the same as that in training with synthetic data. We train the model for 26 epochs. The initial learning rate is set to 0.1 and is reduced by 10 times every 5 epochs. The training loss and the validation loss converge to 0.307 and 0.536, respectively. Therefore, the residual statics errors for the training dataset and validation dataset are 0.614 ms and 1.072 ms, respectively. The predicted results fit the label well. For the convenience of the following description, we call this trained model model-dat.

We apply both model-syn, trained with synthetic datasets, and model-dat, trained with real datasets, to three real datasets from other new exploration areas. For those three test datasets, we apply tomostatics correction first. The same preprocessing as for the training datasets is also conducted for testing data to remove surface waves and refractions, and to balance amplitude. We apply model-syn and model-dat to denoised input in any of the common shot, common receiver, or common midpoint gathers. We iterate the prediction and apply corrections each time. The process is iterated three times.

There are 467 shot gathers. The maximum shot-receiver offset is 3,000 m and the receiver interval is 10 m. The magnitude of static distortions is relatively large. Tomostatics can help correct static distortions, but small visible distortion remains. The residual statics solution from model-syn can further help correct the remaining static distortions. In addition, to globally evaluate the trained model, we compare the stacked sections with different statics corrections. Although the residual statics predicted from model-syn can help improve the stacked section after tomostatics correction, model-dat, which is trained on real datasets, helps produce a slightly better stacked section in terms of event continuity.

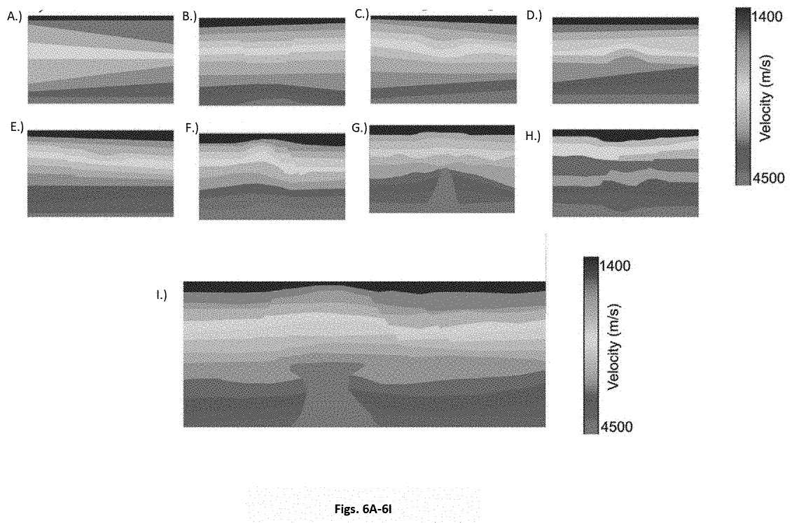

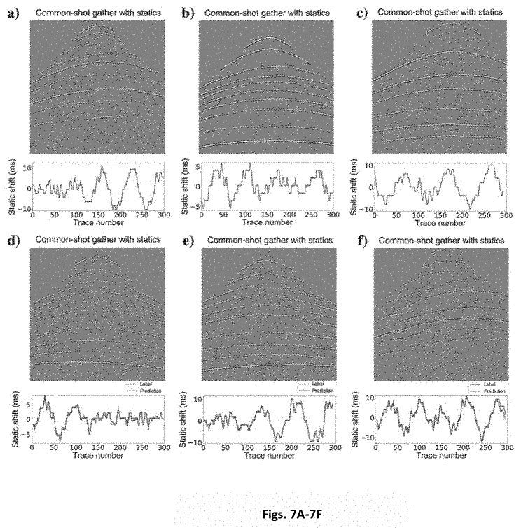

FIGS. 7a-7f illustrate predicted static shift according to an exemplary embodiment.

FIGS. 7a-7c shows three training samples. The model is trained with a batch size of one on four GPUs. We apply the stochastic gradient descent optimizer with a momentum of 0.9 and a weight decay of 0.0001. We train the model for nine epochs. The initial learning rate is set to 0.1, decreasing by 10 times every two epochs. FIG. 7d-7f shows three validation samples and their predictions. Although there is random noise in the input samples, the predicted results fit the label well.

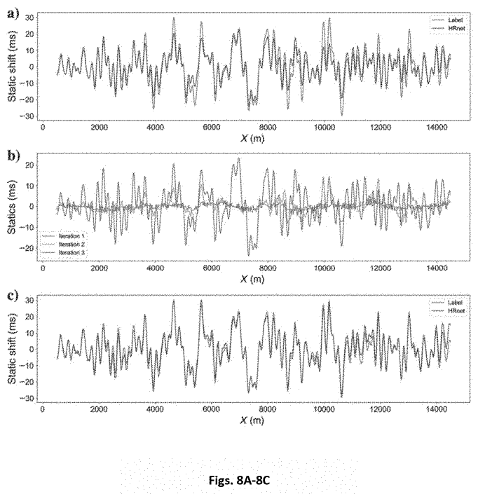

FIGS. 8A-8C are graphs according to an exemplary embodiment.

In addition, large residual statics correction also is a challenge (Rothman, 1986; Stein et al., 2009; Duan and Zhang, 2017). One solution is to synthesize more residual statics with large magnitude and add it to the training data set. In this section, we will show that we can predict the residual statics iteratively using the trained model to deal with the underestimation of residual statics. We generate large magnitude residual statics and apply them to the preceding 400 shot gathers in the test data set. FIG. 8a shows the synthetic residual statics (red curve), and the maximum residual statics is 30 ms. The one-pass prediction result also is shown in FIG. 8A. The residual statics is underestimated. We iterate the prediction process three times and the prediction results in each iteration are shown in FIG. 8B. As the iteration progresses, the predicted residual statics become smaller. We add up the prediction results of those three iterations and the final result is shown in FIG. 8C. The final prediction result fits the large residual statics better than that of only one-pass prediction. In addition, we will apply the trained HRnet model in real applications.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

### CITATIONS

Abbas, A., B. Sarosh, and S. F. Shah, 2018, Computation of residual statics in complex geological areas using simulated annealing method based on minimization of objective function: Journal of Geophysics and Engineering, 15, 2577-2585, doi: 10.1088/1742-2140/aadb21.
Badrinarayanan, V., A. Kendall, and R. Cipolla, 2017, SegNet: A deep convolutional encoder-decoder architecture for image segmentation: IEEE Transactions on Pattern Analysis and Machine Intelligence, 39, 2481-2495, doi: 10.1109/TPAMI.2016.2644615.
Darwish, A., R. R. Haacke, and G. Poole, 2018, De-coupling Residual Statics and Velocity Picking: 80th Annual International Conference and Exhibition, EAGE, Extended Abstracts, doi: 10.3997/2214-4609.201801110.
Duan, X., and J. Zhang, 2017, Residual statics solution by L1 regularized inversion in common offset domain: 87th Annual International Meeting, SEG, Expanded Abstracts, 2696-2700, doi: 10.1190/segam2017-17776509.1.
Hatherly, P. J., M. Urosevic, A. Lambourne, and B. J. Evans, 1994, A simple approach to calculating refraction statics corrections: Geophysics, 59, 156-160, doi: 10.1190/1.1443527.
He, K., X. Zhang, S. Ren, and J. Sun, 2016, Deep residual learning for image recognition: IEEE Conference on Computer Vision and Pattern Recognition, 770-778, doi: 10.1109/cvpr.2016.90.
Hu, L., X. Zheng, Y. Duan, X. Yan, Y. Hu, and X. Zhang, 2019, First-arrival picking with a U-net convolutional network: Geophysics, 84, U45-U57, doi: 10.1190/geo2018-0688.1.
Gao, H., and J. Zhang, 2017, 3D seismic residual statics solutions derived from refraction interferometry: Geophysical Prospecting, 65, 1527-1540, doi: 10.1111/1365-2478.12508.
Gholami, A., 2013, Residual statics estimation by sparsity maximization: Geophysics, 78, V11-V19, doi: 10.1190/geo2012-0035.1.
Ioffe, S., and C. Szegedy, 2015, Batch normalization: Accelerating deep network training by reducing internal covariate shift: arXiv preprint arXiv:1502.03167.
Jin, S., and S. Ronen, 2006, Robust estimation of large surface-consistent residual statics: 68th Annual International Conference and Exhibition, EAGE, Extended Abstracts, doi: 10.3997/2214-4609.201402376.
Koglin, I., J. Mann, and Z. Heilmann, 2006, CRS-stack-based residual static correction: Geophysical prospecting, 54, 697-707, doi: 10.1111/j.1365-2478.2005.00562.x.
Liu, B., S. Yang, Y. Ren, X. Xu, and Y. Chen, 2021, Deep-learning seismic full-waveform inversion for realistic structural models: Geophysics, 86, R31-R44, doi: 10.1190/geo2019-0435.1.
Long, J., E. Shelhamer, and T. Darrel, 2015, Fully convolutional networks for semantic segmentation: IEEE Conference on Computer Vision and Pattern Recognition, 640-651, doi: 10.1109/CVPR.2015.7298965.
Malehmir, A., and C. Juhlin, 2010, An investigation of the effects of the choice of stacking velocities on residual statics for hardrock reflection seismic processing: Journal of Applied Geophysics, 72, 28-38, doi: 10.1016/j.jappgeo.2010.06.008.
Ren, S., K. He, R. Girshick, and J. Sun, 2016, Faster R-CNN: towards real-time object detection with region proposal networks: IEEE transactions on pattern analysis and machine intelligence, 39, 1137-1149, doi: 10.1109/tpami.2016.2577031.
Ronen, J., and J. F. Claerbout, 1985, Surface-consistent residual statics estimation by stack-power maximization: Geophysics, 50, 2759-2767, doi: 10.1190/1.1441896.
Ronneberger, O., P. Fischer, and T. Brox, 2015, U-Net: Convolutional networks for biomedical image segmentation: International Conference on Medical Image Computing and Computer-Assisted Intervention, 234-241.
Rothman, D. H., 1986, Automatic estimation of large residual statics corrections: Geophysics, 51, 332-346, doi: 10.1190/1.1442092.
Simonyan, K., and A. Zisserman, 2014, Very deep convolutional networks for large-scale image recognition: arXiv preprint arXiv:1409.1556, 2014.
Stein, J. A., T. Langston, and S. E. Larson, 2009, A successful statics methodology for land data: The Leading Edge, 28, 222-226, doi: 10.1190/1.3086061.
Sun, K., Y. Zhao, B. Jiang, T. Cheng, B. Xiao, D. Liu, Y. Mu, X. Wang, W. Liu, and J. Wang, 2019, High-Resolution Representations for Labeling Pixels and Regions: arXiv preprint arXiv:1904.04514.
Szegedy, C., W. Liu, Y. Jia, P. Sermanet, S. Reed, D. Anguelov, D. Erhan, V. Vanhoucke, and A. Rabinovich, 2015, Going deeper with convolutions: IEEE Conference on Computer Vision and Pattern Recognition, 1-9, doi: 10.1109/cvpr.2015.7298594.
Taner, M. T., F. Koehler, and K. A. Alhilali, 1974, Estimation and correction of near-surface time anomalies: Geophysics, 39, 441-463, doi: 10.1190/1.1440441.
Wang, J., K. Sun, T. Cheng, B. Jiang, C. Deng, Y. Zhao, D. Liu, Y. Mu, M. Tan, X. Wang, W. Liu, and B. Xiao, 2020, Deep high-resolution representation learning for visual recognition: IEEE transactions on pattern analysis and machine intelligence, doi: 10.1109/TPAMI.2020.2983686.
Wiggins, R. A., K. L. Lamer, and R. D. Wisecup, 1976, Residual statics analysis as a general linear inverse problem: Geophysics, 41, 922-938, doi: 10.1190/1.1440672.
Wilson, W. G., W. G. Laidlaw, and K. Vasudevan, 1994, Residual statics estimation using the genetic algorithm: Geophysics, 59, 766-774, doi: 10.1190/1.1443634.
Wu, X., L. Liang, Y. Shi and S. Fomel, 2019, FaultSeg3D: using synthetic datasets to train an end-to-end convolutional neural network for 3D seismic fault segmentation: Geophysics, 84, IM35-IM45, doi: 10.1190/geo2018-0646.1.
Wu, Y., and K. He, 2018, Group normalization: Proceedings of the European conference on computer vison, 3-19.
Zhang, C., and J. Zhang, 2016, 2D seismic residual statics derived from refraction interferometry: Journal of Applied Geophysics, 130, 145-152, doi: 10.1016/j.jappgeo.2016.04.006.
Zhang, J., and M. N. Toksoz, 1998, Nonlinear refraction traveltime tomography: Geophysics, 63, 1726-1737, doi: 10.1190/1.1444468.
Zhu, W. H., and Y. Luo, 2004, Refraction residual statics using far offset data: Presented at the Geo2004 Conference.

We claim:

1. A method for generating a predictive model configured to correct residual errors in data-mapping, the method comprising the steps of:
retrieving, by a processor, one or more sets of historical data with statics effects removed;
generating, by the processor, one or more sets of synthetic data without statics applied;
generating, by the processor, one or more sets of synthetic residual statics applied to historical data and synthetic data;
analyze, by a predetermined algorithm, one or more trends in the historical data and the synthetic data;
generate, by the processor upon analyzing the trends in the historical data and the synthetic data, a predictive model configured to calculate any errors present in their respective data sets;
apply the predictive model to a current set of a data, the application comprising one or more iterations; and
generate, upon applying the predictive model, one or more visual models with reduced errors.

2. The method of claim 1, wherein the steps further comprise augmenting, upon generating the synthetic data, the synthetic data to train the predictive model.

3. The method of claim 1, wherein the predetermined algorithm is a convolutional neural network (CNN) or a recursive neural network (RNN).

4. The method of claim 1, wherein the sets of historical data, synthetic data, and current data are associated with land and/or shallow marine data.

5. The method of claim 1, wherein the errors present in the data sets are residual statics created by reflecting waves to a common-shot, common-receiver, and common-midpoint (CMP) gathers in two-dimensional or three-dimensional seismic surveys.

6. The method of claim 5, wherein the predictive model for two dimensional seismic surveys may be applied to each line of data acquired from three-dimensional surveys.

7. The method of claim 1, wherein the one or more sets of historical data and synthetic data are separated into one or more training sets and one or more testing sets, the training sets configured to train the historical and synthetic data sets, and the testing sets configured to test the historical data sets and synthetic data sets for static residual accuracy.

8. The method of claim 1, wherein the application is iterated one or more times.

9. The method of claim 1, wherein the predetermined algorithm is a high-resolution neural network configured to allow multiscale training and multiscale testing.

10. A system for generating a predictive model configured to correct residual errors in data-mapping, the system comprising:
a memory; and
a processor configured to:
retrieve on retrieving, by a processor, one or more sets of historical data with statics effects removed;
generate, by the processor, one or more sets of synthetic data without statics applied;
generate, by the processor, one or more sets of synthetic residual statics applied to the historical data and synthetic data;
analyze, by a predetermined algorithm, one or more trends in the historical data and the synthetic data;
generate, by the processor upon analyzing the trends in the historical data and the synthetic data, a predictive model configured to calculate any errors present in their respective data sets;
apply the predictive model to a current set of a data, the application comprising one or more iterations; and
generate, upon applying the predictive model, one or more visual models with reduced errors.

11. The system of claim 10, wherein the generation of the models comprises an average of the errors predicted by the historical and the synthetic data sets.

12. The system of claim 10, wherein the historical data and synthetic data comprise geologic structures.

13. The system of claim 10, wherein the one or more sets of historical data and synthetic data are separated into one or more training sets and one or more testing sets, the training sets configured to train the historical data and/or synthetic data predictive model, and the testing sets configured to test the historical data and/or synthetic data sets for accuracy.

14. The system of claim 13, wherein a predetermined number of training sets and testing sets have been made error-free to further develop the historical data and/or synthetic data.

15. The system of claim 10, wherein the historical data and/or synthetic data each produces its own error-correction suggestion for the current data set.

16. The system of claim 10, wherein the system further comprises a server.

17. The system of claim 10, wherein the system further comprises a database configured to store the historical data, synthetic data, and current data.

18. The system of claim 10, wherein the processor is further configured to generate a graphical representation of the current data set with reduced errors.

19. The system of claim 10, wherein the processor is further configured to augment, upon generating the synthetic data, the synthetic data with random noise, reversed polarity, and cropping.

20. A computer readable non-transitory medium comprising computer executable instructions that, when executed on a processor, perform procedures comprising the steps of:
retrieving, by a processor, one or more sets of historical data with statics effects removed;
generating, by the processor, one or more sets of synthetic data without statics applied;
generating, by the processor, one or more sets of synthetic residual statics applied to the historical data and synthetic data;
analyze, by a predetermined algorithm, one or more trends in the historical data and the synthetic data;
generate, by the processor upon analyzing the trends in the historical data and the synthetic data, a predictive model configured to calculate any errors present in their respective data sets;
apply the predictive model to a current set of a data, the application comprising one or more iterations; and
generate, upon applying the predictive model, one or more visual models with reduced errors.
